(19) United States
(12) Patent Application Publication
(10) Pub. No.: US 2023/0405833 A1
(43) Pub. Date: Dec. 21, 2023

(54) Apparatus and Method for Weighing Food Ingredients In An Automated Cooking Apparatus

(71) Applicant: Kitchen Robotics Ltd., Modiin (IL)

(72) Inventors: David BEN-DAVID, Rehovot (IL); Nikolay SOLDATENKO, Kiryat ONO (IL)

(21) Appl. No.: 17/806,948

(22) Filed: Jun. 15, 2022

(51) Int. Cl. B25J 11/00; A47J 43/07; B25J 9/10; B25J 9/16

(52) U.S. Cl. CPC B25J 11/0045; A47J 43/07; B25J 9/1065; B25J 9/1653; A47J 2043/0733

(57) ABSTRACT

The present invention is an apparatus and method for weighing food ingredient in an ACM during collection of ingredient from a dispenser wherein a the apparatus is provided with collecting apparatus equipped with a moving mechanism (MM), an ingredient-collecting-vessel (ICV) holding mechanism (HM) and a scaling beam.

### FIELD OF THE DISCLOSURE

The present disclosure relates to a weighing apparatus for weighing hot or cold food ingredients in an automated cooking machine (ACM).

### BACKGROUND

In a robotic or automatic cooking environment, cookware weight control is an essential prerequisite for processes such as ingredient collection, real-time feedbacks and system diagnostics. Load-cells are widely used as a force or weight sensors, due to their durability and proven reliability in operating in harsh working conditions. Being a cost effective and relatively accurate measuring component, strain-gauge load cell is often selected.

Strain gauge load cells are a type of load cell where a strain gauge assembly is positioned inside the load cell housing to convert the load acting on them into electrical signals. The weight on the load cell is measured by the voltage fluctuation caused in the strain gauge when it undergoes deformation. Operation of a load cell is well known to a person having ordinary skill in the art and will not be further disclosed.

At an ACM, the food ingredients are collected from an associated dispenser that has a plurality of dispensing-units (DiUs). The food ingredients may be collected by an ingredient-collecting-vessel (ICV). An example of an ICV may be a cooking device, a serving plate, a vessel, a pot, etc.

In some dispensers, a DiU can be associating with a scale device that can measure the weight of the ingredient, which is associated with that DiU, before delivering it. Such a system is accurate but quite expensive due to the cost of the plurality of scale devices. Other dispensers may use a single scale device that is associated with an arm. The arm can carry the ICV. Such a system may have accuracy problems due to parasitic forces that are generated due to the movement of the ICV. These forces may originate from impacts generated during manipulation of the ICV, for example, picking or gripping the ICV from idle position, transferring it from one location to another, etc.

Further, the distribution of the collected ingredients in the vessel is not controlled. The food ingredients may be spread all over the vessel or may be concentrated in one or more sections of the vessel. The sections of the vessel may be in the center and/or close to the edge of the vessel. For one dish the food ingredients may spread all over the vessel and for the following dish, of the same course, the food ingredients may be concentrated in the center. Thus, the location of the ingredients in the vessel is random, which may affect the weighing process of the dish. The uneven distribution of the food ingredients in the ICV not only causes its center of gravity to shift from one ICV to another ICV, but may also shift between different ingredients, recipes as well as dispensed amounts, thereby altering the point of action of the force applied on the load cell such that affecting the torque on the load cell. For example, penne pasta might be dispensed differently than olives, concentrating in certain areas of the ICV. Consequently dishes of the same course may have different taste. Thus, the ACM may deliver inconsistent dishes.

In addition, due to the mass of the ICV and the mass of moving parts of the collecting mechanism an inertial force may resist stopping the moving ICV for executing the scaling process. Thus, in order to execute an accurate scale the ICV has to stop for a certain period of time, before scaling. Such stopping period may minimize the inertial forces. However, the pause, before scaling each ingredient, increases the preparation time of the course and reduces the efficiency of the ACM.

The above defined process of the necessity of weighing in a cooking machine has also been validated in patented inventions. However, these are concentrated mostly in mechanized rather than automated cooking machines.

### PRIOR ART

US20070151774A1 titled, “Food treating apparatus with a weighing scale” talks of a food treating apparatus with a weighing scale. The weighing scale includes a casing, a weight display and a weighing pan. The casing of the weighing scale is provided with a sliding rail or a sliding plate. Correspondingly, the main body of the food treating apparatus is provided with a chamber to accommodate the weighing scale, and within the chamber, a guiding rail is provided for use in conjunction with the sliding rail or sliding plate. The weighing scale can be drawn into or out of the food treating apparatus along the guiding rail. The food treating apparatus with the weighing scale disclosed in the present invention is simple in structure, low in cost and easy to use.

KR0128554B1 titled, “Weight sensing device of microwave-oven” senses the weight of a cooking material provided on a tray to control a strength of a high frequency and a cooking time, is comprised of: a motor (10) provided with an axis (11) for rotating the tray (6); a bracket (20) fixedly installed to the base of a cavity (7), and in which the motor (10) is latched; a plate spring (30) that is a moving-electrode fixedly installed to the base of the bracket (20); and a PCB base material inserted between the bracket (20) and the plate spring (30) in a slide manner, and in which a fixed electrode (41) is formed, wherein the weight of the cooking material is sensed by a change of an capacitance between the plate spring (30) of the moving-electrode and the fixed electrode (41) of the PCB base material (40).

U.S. Pat. No. 7,598,464B2 titled, “Food treating apparatus with a weighing scale” discuss a weighing scale that includes a casing, a weight display and a weighing pan. The casing of the weighing scale is provided with a sliding rail or a sliding plate. Correspondingly, the main body of the food treating apparatus is provided with a chamber to accommodate the weighing scale, and within the chamber, a guiding rail is provided for use in conjunction with the sliding rail or sliding plate. The weighing scale can be drawn into or out of the food treating apparatus along the guiding rail. The food treating apparatus with the weighing scale disclosed in the present invention is simple in structure, low in cost and easy to use.

Taken these inventions into account, the present method discusses the methodology of an apparatus that undertake precise weighing of food ingredients in an automated cooking machine.

### BRIEF SUMMARY

The needs and the deficiencies that are described above are not intended to limit the scope of the inventive concepts of the present disclosure in any manner. The needs are presented for illustration only.

An aspect of the invention is to provide a novel apparatus and method for weighing food ingredient in an ACM during collection of ingredient from a dispenser.

Another aspect of the invention is to provide a collecting apparatus equipped with a moving mechanism (MM), an ingredient-collecting-vessel (ICV) holding mechanism (HM) and a scaling beam.

A still further aspect of the invention is to provide a collecting apparatus with a moving mechanism, configured to carry the ICV along the horizontal axis from left to right and vice versa, parallel to an array of DiUs.

A further aspect of the invention is to provide a collecting apparatus with a moving mechanism, configured to carry the ICV along the vertical axis from up and down and vice versa, from one array of DiUs to another, where the dispenser has two or more arrays of DiUs, one above the other.

Another aspect of the invention is to provide a robotic arm with the collecting apparatus, which is configured to move the ICV in three dimensions (3D), which enables the ICV to be moved towards any DiU associated with the dispenser.

The next aspect of the invention is to provide a holding mechanism which may be a robotic arm associated with electromagnets which are configured to hold and release the ICV in response to the commands received from the controller at the distal end, whereas the proximal end is associated with the moving mechanism via a tilting-element (TE).

A further aspect of the invention is to reduce the influence of the position of the food-ingredients in the ICV by providing a four-beamed arm having a parallelogram mechanism to the ICV holding mechanism.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates a cross-sectional view of a collecting apparatus before starting to collect food-ingredients;

FIG. 2 schematically illustrates a cross-sectional view of a collecting apparatus after collecting some food-ingredients;

FIG. 3 schematically illustrates a cross-sectional view of a collecting apparatus before starting to collect food-ingredients lying upon a scaling beam;

FIG. 4 schematically illustrates a cross-sectional view of a collecting apparatus after collecting some food-ingredients bending the scaling beam;

FIG. 5 schematically illustrates a cross-sectional view of a collecting apparatus before starting to collect food-ingredients lying upon a scaling beam that is associated with another part of the MM; and

FIG. 6 schematically illustrates a cross-sectional view of a collecting apparatus after collecting food-ingredients lying upon the scaling beam that is associated with the other part of the MM.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labelled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably.

The needs and the deficiencies that are described above are not intended to limit the scope of the inventive concepts of the present disclosure in any manner. The needs are presented for illustration only. The disclosure is directed to a novel apparatus and method for scaling food ingredient in an ACM during collection of ingredient from a dispenser.

In the following description and claims, the terms ingredient-collecting-vessel (ICV) can be a pot, a cooking device, a serving plate, a vessel etc. Along the present disclosure and the claims the term ICV may be used as a representative term for this group.

The collecting apparatus of the present invention comprises:
a moving mechanism (MM);
an ICV holding mechanism (HM);
a four-beams-parallelogram-mechanism (FBPM); and
a scaling beam;
wherein, the said moving mechanism (MM) may be configured to carry the ICV along the horizontal axis from left to right and vice versa parallel to an array of DiUs.

In some embodiments of the automated cooking machine (ACM), for dispensers, having two or more arrays of DiUs, placed one above the other, the moving MM may also be configured to carry the ICV along the vertical axis, up and down, from one array of DiUs to the other. The MM may, thus be configured to carry the ICV in a plane, which is parallel to the plane of the DiUs and is located at a distance that allows free movement of the ICV by the MM.

In some example embodiments of the collecting apparatus, the robotic arm may replace the MM. In such embodiments, the robotic arm may be configured to move the ICV in three dimensions (3D), so that the ICV can be moved toward any DiU that is associated with the dispenser.

The ICV HM may comprise one or more electromagnets and an arm. The distal end of each arm may be associated with one or more electromagnets, wherein the one or more electromagnets are configured to hold and release the ICV in response to the commands received from a controller. The proximal end of the arm may be associated with the MM via a tilting-element (TE) which is configured to tilt the arm toward the DiUs in a plane that is perpendicular to the plane of the MM.

In some embodiments the HM may comprise gripping mechanism, instead of electromagnets. The gripping mechanism can be such as but not limited to adaptive-grippe-fingers. Gripping mechanism is well known to a person having ordinary skill in the art and will not be further disclosed. In some embodiments the gripping mechanism can be activated by electrical power or magnetic power or pneumatic power, air-pressure, etc.

In some example embodiments, the arm of the ICV HM may have a shape of four beams parallelogram mechanism, for reducing the influence of the location of the food-ingredients in the ICV. The parallelogram may comprise three beams plus a virtual beam. The virtual beam may comprise the section of the MM between two pivots that associate the parallelogram with the MM. The one or more electromagnets, or other gripping mechanism, can be associated with the beam that is perpendicular to the virtual beam.

In some example embodiments of the collecting apparatus, the four beams parallelogram mechanism may be placed at an angle to the MM, which is opposite to the angle that is generated when the TE places the ICV below the relevant DiU. Thus, when the ingredients fall into the ICV the scaling beam measures the force of gravity.

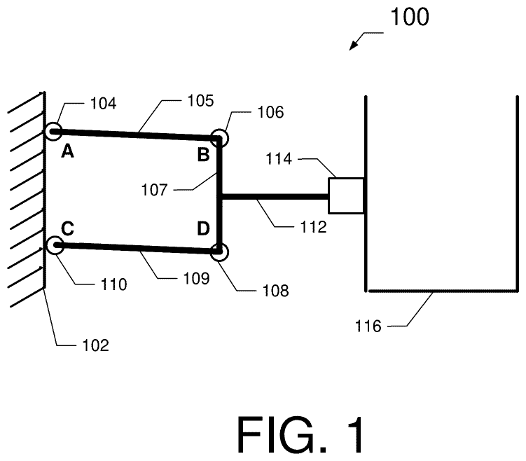

The mechanism of four-beam-parallelogram-mechanism (FBPM) is explained in more detail in the following paragraphs with reference to FIGS. 1-6.

The scaling beam is associated with a load-cell and an electronic circuit that are configured for delivering voltage changes according to the bending or deformation of the scaling beam.

The voltage from the electronic circuit may be converted into digital form by an A/D converter. The digital presentation of the voltage may be converted into scaling units such as but not limited to grams by a look up table (LUT) which may be embedded in a non-transitory computer readable storage device. The address bits of the LUT may be the digital presentation of the voltage that is currently measured while the data that is stored in that address is in grams, for example.

In some embodiments of the collecting apparatus, the arm of the ICV HM may be placed over the scaling beam. Consequently, the scaling beam may measure the normal force and may ignore parasitic forces.

The parasitic forces may comprise impact forces from the ICV HM while picking the ICV or releasing the ICV. Other parasitic forces may be driven from accelerating or deaccelerating the ICV. Yet, another parasitic force can be inertial forces that resist changes in the position of the ICV.

FIG. 1 schematically illustrates a cross-sectional view of a collecting apparatus 100 before starting to collect food-ingredients. The collecting apparatus 100 may comprise a moving mechanism (MM) 102, four-beams-parallelogram-mechanism (FBPM). The FBPM may comprise three beams 105, 107 and 109 plus a virtual beam 107a. The virtual beam 107a may comprise part of the MM 102, which is between two pivots, a first pivot 104 and a third pivot 110. Pivots 104 and 110 associate the FBPM with the MM 102. Pivots, namely first pivot A 104, a second pivot B 106, a third pivot C 110 and a fourth pivot D 108 enable the movement of beam 107 up and down in parallel to the virtual beam 107a.

In the example embodiment of the collecting apparatus 100, beam 107 can be associated with an ICV HM. The ICV HM can comprise an arm 112 and a HM 114. One end of the arm 112 can be connected to the center of beam 107 while keeping the arm 112 perpendicular to beam 107. The other end of arm 112 can be associated with the HM 114. In some embodiment of collecting apparatus 100, the HM 114 may comprise one or more electromagnets that are configured to hold and release the ICV 116 according to commands received from a controller (not shown in the figure).

Other example embodiments of HM 114 may comprise a gripping mechanism, instead of electromagnets (not shown in the figures). The gripping mechanism can be such as but not limited to adaptive-grippe-fingers. In some embodiments of collecting apparatus 100 the gripping mechanism 114 can be activated by electrical power or magnetic power or pneumatic power or air-pressure, etc. Gripping mechanism is well known to a person having ordinary skill in the art and will not be further disclosed.

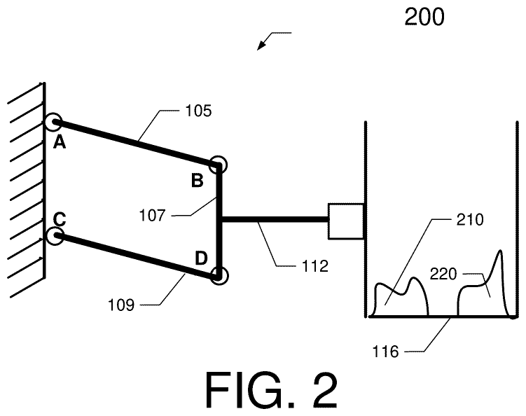

FIG. 2 schematically illustrates a cross-sectional view of a collecting apparatus 200 after collecting food-ingredients 210 and 220. As it is demonstrated the food-ingredients 210 and 220 are spread over the ICV 116. Food-ingredient 210 is placed near the HM 114. While Food-ingredients 220 is placed at the far end of ICV 116, which is far from HM 114. The location of the ingredients 210 and 220 in the ICV 116 is random, which may affect the weighting process of the ICV 116. The location of food-ingredients 210 and 220 causes the center of gravity of ICV 116 to shift from one ICV 116 to another ICV.

Due to the structure of FBPM (105, 107, 109 and 107a) beam 107 moves down parallel to MM 102 forcing the ICV 116 to move down in parallel to the force of gravity. The distance of movement down of ICV 116 depends on the weight of the food-ingredients 210 and 220. The displacement of pivot D 108 between the origin location, without the food-ingredients 210 and 220, as it is illustrated in FIG. 1, and the location 208 as it is illustrated in FIG. 2 is function of the weight of the food-ingredients 210 and 220.

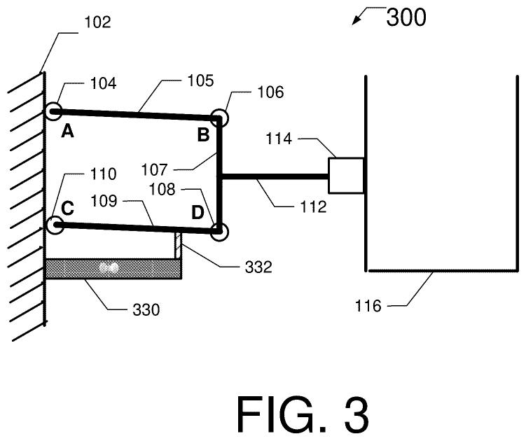

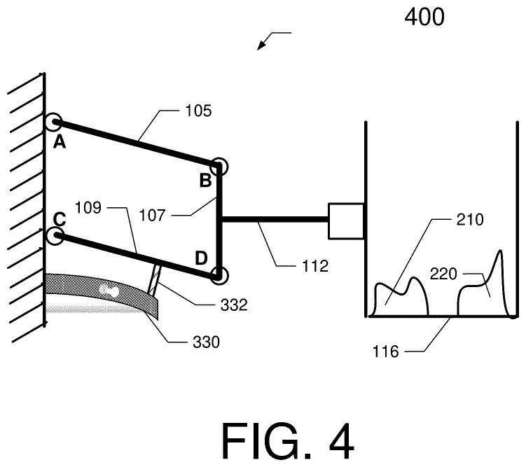

FIG. 3 schematically illustrates a cross-sectional view of a collecting apparatus 300 lying above a scaling beam 330, wherein the ICV 116 is empty. In some example embodiments of collecting apparatus 300 an adaptor 332 can be added between beam 109 and the scaling beam 330. The adaptor 332 is not fixed to the scaling beam 330 it just placed over the scaling beam. The adaptor 332 is used for enabling free bending of the scaling beam 330 as it is illustrated in FIG. 4. Some example embodiments (not shown in the figures) of collecting apparatus may not use an adaptor. In those embodiments beam 109 or pivot D may lay directly on the scaling beam 330.

Scaling beam 330 can comprise a load-cell 332. Load-cell 332 can comprise a strain gauge assembly. The strain gauge assembly can convert the load acting on the scaling beam 330 into electrical signals. The weight of the ICV with the food-ingredients 210 and 220 can be measured by voltage fluctuation caused in the strain gauge when it undergoes deformation. Operation of a load cell is well known to a person having ordinary skill in the art and will not be further disclosed. An example of load-cell 332 can be aluminium alloy 10 kg capacity bending beam load cell, 5 VDC excitation voltage, 0.5 mV/V rated output, 0.1% nonlinearity and 0.1% hysteresis.

The voltage fluctuation from the load-cell can be delivered to an electronic circuit, converted into digital by an A/D converter. The digital presentation of the voltage can be converted into scaling units such as but not limited to grams by a look-up-table (LUT). The LUT can be embedded in a non-transitory computer readable storage device. The address bits of the LUT can be the digital presentation of the voltage that is currently measured while the data that is stored in that address is in grams, for example.

Other example embodiment of the disclosed technique, not shown in the figures, may use a potentiometer in order to measure the displacement of pivot D 108. The potentiometer can be connected to an electronic circuit. In such embodiment pivot D can be associated with a sliding contact of the potentiometer. Thus, the resistance of the potentiometer is function of the displacement of pivot D 108. The electronic circuit can be configured to deliver constant current via the potentiometer and measure the voltage at the sliding contact. This voltage if function of the displacement and can converted into digital by an A/D converter. The digital presentation of the voltage can be converted into scaling units such as but not limited to grams by a look-up-table (LUT). Using potentiometer as measuring tool is well known to a person having ordinary skill in the art and will not be further disclosed.

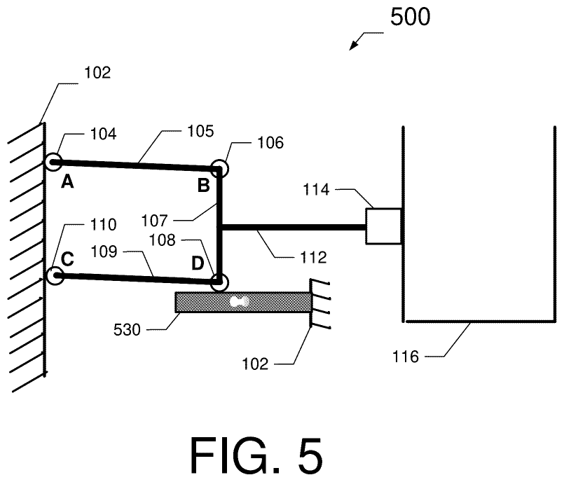

FIG. 5 schematically illustrates a cross-sectional view of a collecting apparatus 500 in which pivot D lies above a scaling beam 530 and wherein the ICV 116 is empty. In some example embodiments of collecting apparatus 500 the scaling beam 530 can be associated with a section 102a (not marked) of the MM of the collecting apparatus 500, which is other than section 102. In some embodiments of the collecting apparatus 500 section 102a can be parallel to section 102 of the MM of the collecting apparatus 500. In such configuration pivot D may lie directly on the scaling beam 530 without being fixed to it.

Scaling beam 530 can be associated with a load-cell 532. Load-cell 532 can comprise a strain gauge assembly. The strain gauge assembly can convert the load acting on the scaling beam 530 into electrical signals. Other example embodiment of the disclosed technique, not shown in the figures, may use a potentiometer in order to measure the displacement of pivot D. The potentiometer can be connected to an electronic circuit. In such embodiment the edge of the scaling beam can be associated with a sliding contact of the potentiometer,

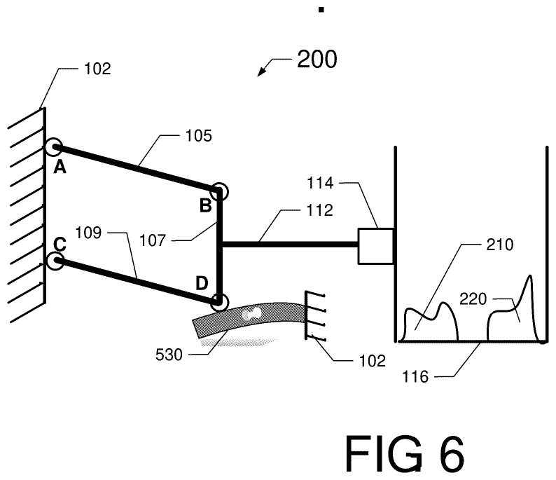

As illustrated in FIG. 6 the weight, the power of gravity, of ICV 116 with the food-ingredients 210 and 220 may be transferred via the four beams parallelogram mechanism to pivot D. This power of gravity bends the scaling beam 530. The deformation of scaling beam 530 may cause voltage fluctuation in the strain gauge of load-cell 532. This voltage fluctuation is function of the displacement of pivot D and can be converted into digital by an A/D converter. The digital presentation of the voltage can be converted into scaling units, such as but not limited to grams, by a look-up-table (LUT).

Other example embodiments of the collecting apparatus, not shown in the figures, may use a potentiometer in order to measure the displacement of pivot D. The potentiometer can be connected to an electronic circuit. In such embodiment pivot D can be associated with a sliding contact of the potentiometer, thus, the resistance of the potentiometer becomes a function of the displacement of pivot D. The electronic circuit can be configured to deliver constant current via the potentiometer and measure the voltage at the sliding contact. This voltage is function of the displacement and can converted into digital by an A/D converter. The digital presentation of the voltage can be converted into scaling units such as but not limited to grams by a look-up-table (LUT).

Method of Collecting Ingredients by the Collecting Apparatus:

Upon receiving instructions from the controller, the moving mechanism is activated, which moves towards the station containing the sanitized ICVs;

A further instruction from the controller, results in activating the tilting-element (TE), which turns the arm towards the first ICV for collecting the ICV. At this stage, the electromagnets of the distal part of the arm are also activated, for holding the first ICV.

The tilting-element (TE) tilts the arm backward, carrying the first ICV, towards the moving mechanism (MM); the tilting element (TE), may further, perform single or multiple motion axis movements, for gripping and picking up the clean ICV, depending upon the position of the ICV.

The ICV is carried by the MM, towards the first DiU, depending upon the ingredients of the recipe, where it pauses upon reaching the first DiU.

The tilting-element (TE), tilts the arm for conveying the ICV towards and below the first DiU.

The first DiU receives instructions, to deliver its ingredients into the ICV, once the ICV is placed below the first DiU.

Once the ingredients with the specific weight is delivered by the DiU, the arm of the collecting apparatus is tilted backwards by the tilting-element, carrying the ICV towards the moving mechanism;

The next ingredient is also collected, depending upon the recipe of the required course, following the steps from 4 to 8, wherein the MM carries the ICV to a defined position in front of the second DiU for collection of the ingredients.

The above method further includes, after the step of 6, weighing the ICV by means of load cell associated with the said arm, and, during delivery of the ingredients, upon reaching the specific weight, instructing the DiU to stop delivering the ingredients.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

What is claimed is:

1. A collecting apparatus comprising:
i. a moving mechanism (MM);
ii. a four-beams-parallelogram-mechanism (FBPM) that is associated with the MM by two pivots and wherein the FBPM comprises three beams and a virtual beam wherein the virtual beam is part of the MM that resides between the two pivots;
iii. an arm, wherein the proximal end of the arm is connected to a second beam of the FBPM and wherein the second beam is parallel to the virtual beam and the arm is perpendicular to the second beam, and wherein the distal end of the arm is associated with an ingredient-collecting-vessel (ICV) holding mechanism (HM); and
iv. a scaling beam, wherein one end of the scaling beam is associated with the MM and the other end lays below the FBPM;
wherein the scaling beam is configured to measure the displacement of the second beam that is due to adding an ingredient to the ICV; and
wherein the MM is configured to carry an ICV from one dispensing-unit (DiU) toward another DiU.

2. The collecting apparatus of claim 1, wherein the said arm is configured to move the ICV in three dimensions (3D).

3. The collecting apparatus of claim 1, wherein the ICV HM comprises electromagnet.

4. The collecting apparatus of claim 1, wherein the ICV HM is equipped with a gripping mechanism.

5. The collecting apparatus of claim 1, wherein the said arm associated with the ICV HM is equipped with a tilting element (TE), configured for tilting the said arm towards the DiU plane perpendicular to the plane of the MM.

6. The collecting apparatus of claim 1, wherein the said scaling beam is associated with a load-cell.

7. The collecting apparatus of claim 1, wherein the scaling beam is associated with a potentiometer.

8. The collecting apparatus of claim 1, wherein the said scaling beam is associated with an electronic circuit, wherein, an A/D converter converts the voltage into digital form, and wherein a look-up-table (LUT) converts the digital presentation of the voltage into scaling units.

9. The collecting apparatus of claim 1, wherein an adaptor, placed between the beam comprising the third and fourth pivots of the FBPM and the scaling beam, enables free bending of the scaling beam during weighing of the ingredients.

10. A method of collecting and weighing ingredients by the collecting apparatus of an automatic cooking machine, the method comprising the steps of:
Step 1: Upon receiving instructions from the controller, the moving mechanism is activated, which moves towards the station containing the sanitized ICVs;
Step 2: activating the tilting-element (TE), in response to the instructions received from the controller which turns the arm towards the first ICV for collecting the ICV, wherein, the electromagnets of the distal part of the arm are also activated, for holding the first ICV;
Step 3: the tilting element (TE), upon being activated, performs single or multiple motion axis movements, for gripping and picking up the clean ICV, depending upon the position of the ICV;
Step 4: Carrying the ICV by the MM, towards the first DiU, depending upon the ingredients of the recipe, where it pauses upon reaching the first DiU;
Step 5: tilting the arm for conveying the ICV towards and below the first DiU by the tilting element (TE);
Step 6: receiving instructions by the first DiU for delivering its ingredients into the ICV, once the ICV is placed below the first DiU;
Step 7: tilting the arm of the collecting apparatus backwards by the tilting element (TE) and carrying the ICV towards the moving mechanism, once the ingredients with the specific weight is delivered by the DiU;
Step 8: collecting the next ingredient, depending upon the recipe of the required course, following the steps from 4 to 7, wherein, the MM carries the ICV to a defined position in front of the second DiU for collection of the ingredients.

11. The method of claim 10, wherein the method further comprises, after the step of 6, weighing the ICV by means of load cell associated with the said arm, and, during delivery of the ingredients, upon reaching the specific weight, instructing the DiU to stop delivering the ingredients.

12. The method of claim 10, wherein the accurate weighing of the ingredients of the recipe is by means of four beam parallelogram mechanism (FBPM), the moving mechanism (MM) and the scaling beam.

13. The method of claim 12, wherein the said four beam parallelogram mechanism is associated with the MM by two pivots and wherein the FBPM comprises three beams and a virtual beam wherein the virtual beam is part of the MM that resides between the two pivots.

14. The method of claim 12, wherein one end of the said scaling beam is associated with the MM and the other end lies below the FBPM.

15. The method of claim 12, wherein the said scaling beam is configured to measure the displacement of the second beam that is due to adding an ingredient to the ICV.

16. The method of claim 12, wherein the said MM is configured to carry an ICV from one dispensing-unit (DiU) toward another DiU.
